(19) United States
(12) Patent Application Publication
(10) Pub. No.: US 2008/0122683 A1
(43) Pub. Date: May 29, 2008

(54) Monopulse antenna tracking and direction finding of multiple sources

(75) Inventors: Robert J. Howley, Melbourne, FL (US); William C. Daffron, Cocoa, FL (US); Scott J. Hemlinger, West Melbourne, FL (US); Anthony J. Gianatasio, Indialantic, FL (US)

Correspondence Address: DARBY & DARBY (formerly Sacco & Associates), P.O. BOX 770, CHURCH STREET STATION, NEW YORK, NY, 10008-0770, US

(73) Assignee: HARRIS CORPORATION, Melbourne, FL (US)

(21) Appl. No.: 11/482,239

(22) Filed: Jun. 30, 2006

(51) Int. Cl. G01S 13/00

(52) U.S. Cl. 342/149

(57) ABSTRACT

System and method for finding a direction of two or more secondary RF sources arrayed about a position of a primary RF source (X₁). The system includes an antenna system (500) coupled to a monopulse tracking system (100) for determining a position of a primary RF source relative to a boresight axis (502) of the antenna system. The system includes a monopulse direction finding system (600) coupled to the antenna system responsive to RF signals from two or more secondary RF sources (Y₁, Y₂) having at least one of a different frequency and a different polarization as compared to the primary RF source.

### BACKGROUND OF THE INVENTION

1. Statement of the Technical Field

The invention concerns monopulse tracking systems, and more particularly, systems for producing antenna tracking error signals and concurrent tracking of nearby signal sources.

2. Description of the Related Art

Monopulse or pseudo-monopulse tracking systems are typically used in one of two ways. In some systems, the monopulse technique is used for measuring an angle of arrival of an incoming RF signal relative to a boresight direction. In other systems, monopulse techniques are used for tracking to control a boresight direction of an antenna. Once the target is acquired, in such systems, it can be tracked by controlling the orientation of the antenna from the angle output of the tracking system in a closed servo loop. A third type of application which has been suggested is instantaneous angle scanning over the full width of the beam. In such systems, information on range, azimuth, and elevation bearings for all targets within the range of the system would be plotted each time the antenna mount made a single revolution. See, e.g. D. R. Rhodes, Ph.D.: Introduction to Monopulse”, Artech House, Inc., (Dedham, Mass.), pp. 8-9, 1980

Tracking and/or direction-finding systems require that the antenna system function as an angle of arrival detector for received signals. The three basic types of angle detection include systems based on amplitude, phase, or sum and difference antenna patterns. However, sum and difference based systems are often preferred as they offer the greatest dynamic stability.

In a conventional sum and difference type monopulse tracking system an antenna system is used to generate at least two distinct antenna patterns. Generally, these two patterns are referred to as a sum and difference pattern. There are many different antenna structures that can be used to generate the sum and the difference beam. Regardless of the technique, the sum beam usually comprises a peak gain on boresight, whereas the difference beam generally exhibits a null on boresight. In conventional “generic” monopulse tracking systems, the sum channel and difference channel are typically communicated simultaneously to a detector, where the relative amplitude and phase of a received signal in the difference channel is compared to the received signal in the sum channel to produce angular error signals.

In a “pseudomonopulse” system, a phase shifter is typically used to combine the sum and difference beams to control the squint direction relative to boresight. Combining the sum and difference channel beams in this way results in a squinting of the sum channel beam at some angle slightly displaced from boresight. In other words, the peak gain of the sum channel appears offset slightly from boresight when the difference channel is coupled to the sum channel. The extent of the angular displacement will depend on the amount of coupling. In order to control the beam squint process described herein, one or more control bits are typically used. For example, a tracking system that operates in only a single axis (azimuth) would require one control bit to squint the beam left (0) and right (1) of boresight. In actual practice, it is usually necessary for a tracking system to track a target along two typically orthogonal axes (usually azimuth and elevation). For such systems, two data bits are generally needed to control the system. The two data bits provide 4 control states, i.e. two beam scan positions for two axes.

The phase shifter device used to scan or squint the beam as described herein is selectively controlled to quickly vary the phase between two positions. A single phase shifter can be used for each axis. One or more phase shifters can be used to provide 0° phase shift and 180° phase shift for any two orthogonal planes, such as azimuth and elevation. Switching the phase shifter between these two positions results in the two squinted sum channel antenna patterns for each plane. Some antenna systems use a slightly different arrangement as compared to that which has been thus far described. For example, some existing systems generate circularly symmetric amplitude beam for the difference antenna in which the phase rotates 360° around boresight. In the case of such circularly symmetric amplitude beams, a 0°/180° and 90°/270° phase shift are used to form two scanned beams in orthogonal planes.

### SUMMARY OF THE INVENTION

A method for tracking a position of a plurality of secondary RF sources arrayed about a position of a primary RF source. The method includes tracking with an antenna system a position of a primary RF source using monopulse or pseudomonopulse tracking. The tracking includes automatically adjusting a boresight position of the antenna system so that it is aligned with a position of the primary RF source. The method also includes using signals received with the antenna system to concurrently determine a position of a plurality of secondary RF sources arrayed about a position of the primary RF source, where the secondary RF sources have a different frequency and/or a different polarization as compared to the primary RF source. This determining step comprises using a monopulse or pseudomonopulse direction finding technique. The monopulse or pseudomonopulse tracking step is performed using signals received from a first RF feed, and the monopulse or pseudomonopulse direction finding step is performed using signals received from a second RF feed. The method also includes positioning the first RF feed and the second RF feed on a common rotating structure. The first RF feed is selected to have at least one of a different polarization and/or a different operating frequency band as compared to the second RF feed.

According to one aspect of the invention, the communication antenna system is selected to include a first and second antenna aperture. For example, each of the first and second antenna apertures can be selected from the group consisting of a reflector type antenna and/or an array type antenna. Alternatively, a common reflector is used to focus RF signals from the primary RF source toward the first RF feed, and from the secondary RF source toward the second RF feed. In this regard, the first and second RF feed advantageously are selected to include a microwave horn. According to one aspect of the invention, the first and the second RF feed each define a prime focus feed system for the common reflector. However, in one embodiment, the method also includes positioning a subreflector in a path of RF signals communicated from the common reflector to the first and the second RF feed. The subreflector can be a conventional subreflector. Alternatively, the subreflector is formed as a frequency selective surface. In that case, the RF signals are communicated to the first or second RF feed horn through a surface the subreflector.

The position of the plurality of secondary RF sources is determined using information obtained from the monopulse or pseudomonopulse tracking and the monopulse or pseudomonopulse direction finding. The step of determining a position of the plurality of secondary RF sources includes determining an angular position difference between the primary RF source and at least one secondary RF source using information obtained from the tracking and the direction finding. This information can thereafter be used to determine a relative distance between the primary RF source and at least one of the secondary RF sources. It is also used for determining a distance between two or more secondary RF sources. This feature is particularly useful where the primary RF source and the secondary RF sources comprise a cluster of earth orbiting satellites. The position of the secondary RF source generally should be within its main beamwidth when the common antenna structure is pointed towards the primary source or a means provided to get it within its main beam without moving the primary RF beam.

The invention also concerns a system for finding a direction of a plurality of secondary RF sources arrayed about a position of a primary RF source. The system includes an antenna system coupled to a monopulse or pseudomonopulse tracking system. The tracking system is configured for determining a position of a primary RF source relative to a boresight axis of the antenna system, and for automatically adjusting a boresight position of the antenna system to follow the primary RF source. The antenna system includes a first RF feed configured for receiving signals from the primary RF source, and a second RF feed configured for receiving signals from at least one secondary RF source. The first RF feed is advantageously arranged to have at least one of a different polarization and a different operating frequency band as compared to the second RF feed. The second frequency can be in the same band as long as there is adequate frequency separation for the signals to be isolated in the receive chain. The first RF feed and the second RF feed are mounted together on a common rotating structure. A monopulse or pseudomonopulse direction finding system is coupled to the second RF feed and is responsive to RF signals having at least one of a different frequency band and a different polarization as compared to the primary RF feed.

According to one aspect, the antenna system comprises a first and second antenna aperture mounted on the single rotating structure, the first and second aperture are respectively coupled to the tracking system and the direction finding system. For example, the first and second aperture can be selected from the group consisting of a reflector type antenna and an array type antenna.

In an alternative arrangement, the first RF feed horn is positioned so that RF signals for monopulse or pseudomonopulse tracking of the primary RF source are communicated from a reflector to the first RF feed horn. The second RF feed horn is positioned so that RF signals for monopulse or pseudomonopulse direction finding of the plurality of secondary RF source are communicated from the reflector to at least the second RF feed horn. Accordingly, the common reflector is used for both horns. In one such arrangement, the first and second RF feed horn are positioned so as to define a prime focus feed system for the reflector exclusive of any subreflector. However, in another arrangement, a subreflector is positioned in a path of RF signals communicated from the reflector to the first and the second RF feed horn. Further, the subreflector can be designed to be a frequency selective surface that is transmissive with respect to RF signals from the primary RF source or the secondary RF sources.

The system also includes processing means for determining an angular difference in position as between the primary RF source and one or more secondary RF sources. For example, the processing means can include hardware and suitable software for determining such angular distance based on information from the tracking system and the direction finding system.

### BRIEF DESCRIPTION OF THE DRAWINGS

Embodiments will be described with reference to the following drawing figures, in which like numerals represent like items throughout the figures, and in which:

FIG. 1 is a block diagram of a monopulse antenna tracking system of the prior art.

FIG. 2 is a block diagram of a pseudo-monopulse tracking system of the prior art.

FIG. 3A is a plot showing sum and difference antenna patterns that can be generated by the feed and comparator in FIG. 1.

FIG. 3B is a plot showing a sum beam squinted to the left and the right of boresight.

FIG. 3C is a plot showing an error signal produced for a primary source and a secondary source using plots similar to those sum and difference patterns in FIG. 3A.

FIG. 4 is a drawing that is useful for understanding a scan plane in a monopulse antenna tracking system.

FIG. 5 is a drawing that is useful for understanding the manner in which a plurality of satellites can appear within a beam of a pseudomonopulse tracking antenna.

FIG. 6 is a block diagram that is useful for understanding a system using monopulse tracking methods for direction finding multiple RF sources.

FIG. 7 is a drawing that shows a multiple-aperture antenna system that includes a reflector antenna and a set of array antennas.

FIG. 8 is a schematic representation that shows a modified Cassegrain antenna geometry which includes dual RF feeds.

FIG. 9 is a schematic representation that shows a prime focus reflector antenna with multiple RF feeds.

FIG. 10 is a schematic representation that shows a Cassegrain antenna geometry with a subreflector and multiple RF feeds.

FIGS. 11A and 11B are two perspective views of a dual RF feed.

### DETAILED DESCRIPTION OF THE PREFERRED EMBODIMENTS

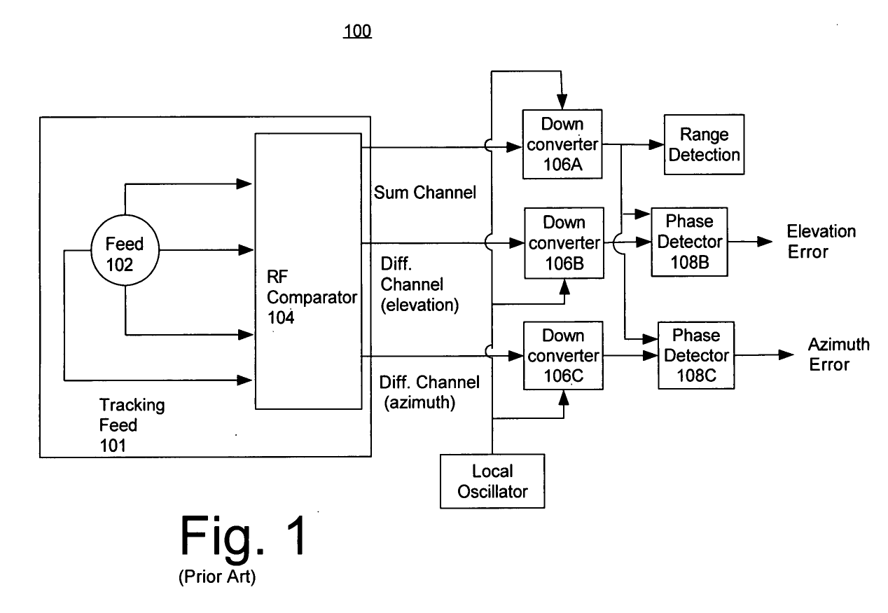

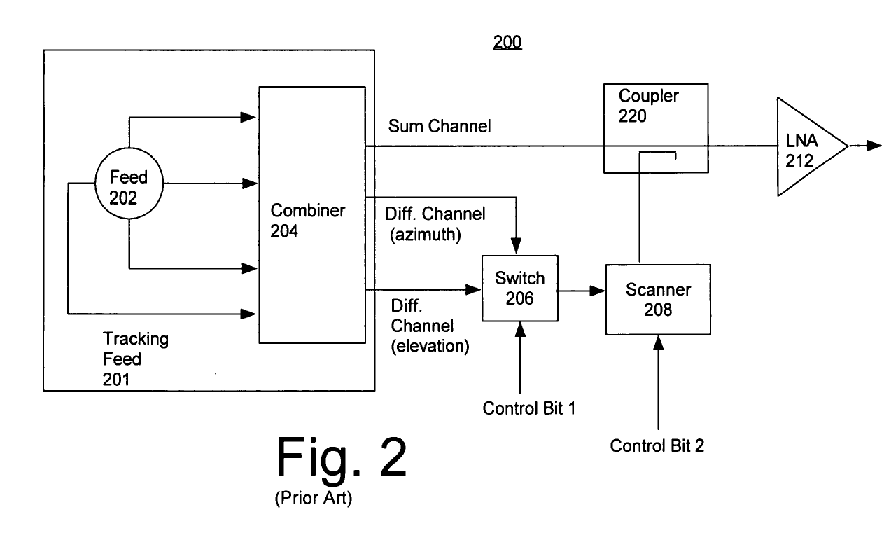

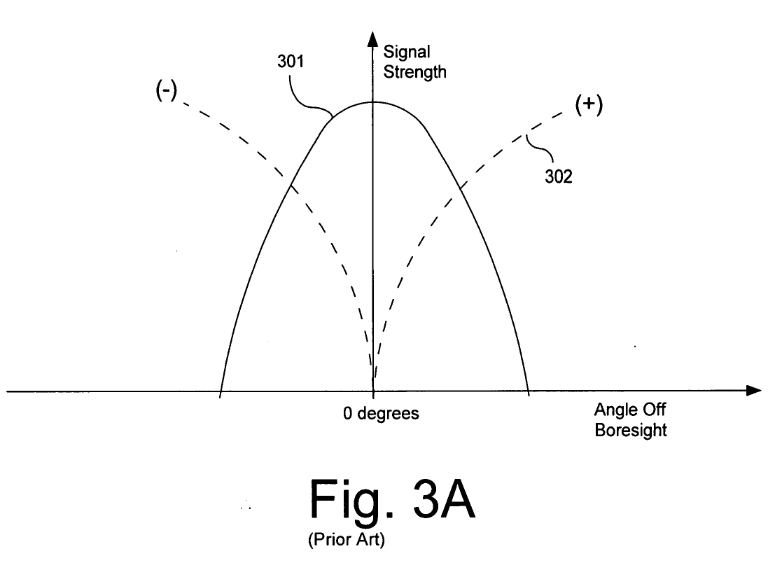

FIGS. 1 and 2 are block diagrams that shows a conventional monopulse antenna tracking (MAT) system 100 and also a pseudo-monopulse antenna tracking (PMAT) system 200. The MAT system 100 includes a conventional tracking feed 101 comprised of feed 102 and an RF comparator 104. The PMAT system 200 similarly includes a tracking feed 200 comprised of a feed 202 and an RF comparator 204. Those skilled in the art will readily appreciate that the feed 102 and the RF comparator 104 can be selected to operate cooperatively to produce sum and difference antenna channels as shown in FIG. 3A. The sum and difference antenna channels are conventionally associated with certain types of well known antenna patterns which are substantially as shown in FIG. 3A.

Comparators 104, 204 typically include one or more conventional hybrid junctions used for RF dividing and combining functions. Those skilled in the art will appreciate that the particular type of RF comparator used in a particular instance will depend on a variety of factors, including the type of antenna selected and feed that is used. Further, it will be appreciated that the tracking feeds 101, 201 can generate a difference channel representing a difference antenna pattern in an azimuthal plane and a second difference pattern aligned in the plane of elevation for the antenna. Pseudomonopulse systems are more commonly used in communications terminals due to the inherent lower cost due to fewer RF components and electronics. Most of the following discussions will be directed to the PMAT, but the invention is just as applicable for the MAT.

Referring again to FIG. 100 for the MAT, it can be observed that the sum channel and difference channel signals are each converted from an RF signal to an IF signal in a down-conversion process. The down-conversion process is performed in down-converter 106a, 106b, and 106c. Thereafter, the IF signal for the elevation difference channel elevation and azimuth difference channel are respectively communicated to phase-sensitive detectors 108b and 108c. The phase-sensitive detectors 108b, 108c respectively produce an elevation error signal and an azimuth elevation signal. These error signals are related to the ratio of the sum and difference and proportional to the off-axis angle of the received signals in the elevation and azimuth planes.

Referring to FIG. 200 for the PMAT, it can be observed that the sum channel and difference channel signals are each communicated to a coupler 220, where a portion of a received signal in the difference channel can be coupled to the received signal in the sum channel. The actual amount of coupling will be selected by a system designer and will depend on a number of factors. Typical coupling values for these types of system can range between 6 dB and 16 dB. Regardless of the specific coupler selected, combining the sum and difference channel beams in this way results in a squinting of the sum channel beam at some angle slightly displaced from boresight. In other words, when the sum channel signal is measured at the output of the coupler 220, the peak gain of the sum channel appears offset slightly from boresight when the difference channel is coupled to the sum channel. The extent of the angular displacement will depend on the amount of coupling. This is done sequentially in azimuth and elevation by switch 206 and the scanner 208.

A scanner 208 is used to control the squint direction relative to boresight. Typically, the scanner 208 will be comprised of a variable phase shifting device. For example, the scanner 208 can be selectively controlled to quickly vary the phase between two positions defined as a 0° phase shift and 180° phase shift. Switching the scanner between these two positions results in the two sum channel antenna patterns 301-1, 301-2 shown in FIG. 3B at the output of coupler 220.

Referring now to FIG. 3B, there is shown a drawing that is useful for understanding how a pseudomonopulse tracking error is conventionally generated in a particular plane (azimuth or elevation). In FIG. 3B, it can be observed that a signal arriving at some angle θ will be received in beam 301-1 at a power level P_{L}. In contrast, the same signal will be received in beam 301-2 at a power level P_{R}. It will be appreciated that in FIG. 3B, the relative difference in received power or the ratio between the two power levels P_{R} and P_{L} can be used to generate an error signal that uniquely defines the angle θ. For example, the tracking error signal for each angular position can be defined as follows:

$$Tracking Error Signal = \hat{e} = \frac{{\hat{P}}_{R} - {\hat{P}}_{L}}{{\hat{P}}_{R} + {\hat{P}}_{L}}$$

where \hat{P}_{R} and \hat{P}_{L} are the average values of P_{R} and P_{L}, respectively. If the tracking error signal values are plotted as a function of angle, an error curve is created over an angular region defined by the first null of the sum pattern. This error curve is predictable and can be generated by analysis or measured results. For example, FIG. 3C shows an example of an error signal curve 306. The error signal curve 306 is a plot of error signal voltage versus angular offset from antenna boresight as generated by the pseudo-monopulse tracking system described herein.

The output of coupler 220 can be provided to a low-noise amplifier 212 to provide some signal gain. Thereafter, the signal can be coupled to a tracking control system where the tracking error, including both magnitude and direction, can be determined. The tracking error signal generated by the pseudo-monopulse system is used in a look-up-table or curve fit equation from FIG. 3C to determine a value for an angle θ. This process can be performed with respect to two orthogonal planes, such as azimuth and elevation.

Thus far, the pseudo-monopulse tracking system in FIG. 2 has been described with respect to a single difference channel. A single difference channel can be satisfactory for tracking a target in a single plane. In practice, however, it is common to provide a difference channel output from RF comparator 204 aligned in the azimuth and elevation planes. As shown in FIG. 2, an RF switch 206 can be used to selectively determine which of these two difference channel signals are communicated to the scanner 208. The two difference channels can be used in the manner previously described herein to produce a tracking error signal for the antenna azimuth and elevation.

The RF switch 206 selectively controls whether the sum channel is coupled with a difference antenna pattern aligned in the azimuth plane or a difference antenna pattern aligned with the elevation plane. Like the phase shifter described above, the RF switch requires at least one control bit. This control bit is used to selectively alternate between the two difference antenna patterns for the purpose of generating tracking error signal vectors respectively aligned with the azimuth and elevation planes. From the foregoing, it will be understood that at least two control bits are generally required for generating pseudomonopulse tracking error data where it is desired to include error vectors in both an azimuth and elevation plane. In FIG. 2, these are shown as Control Bit 1 and Control Bit 2.

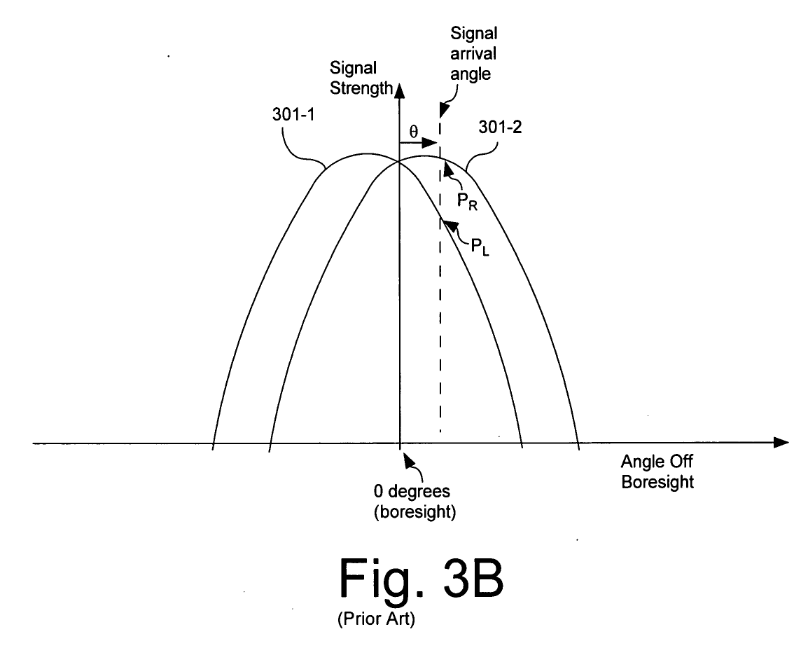

As shown in FIG. 3B, a pseudomonopulse tracking system will squint an antenna beam in an azimuth plane by some angle θ to determine a position of an RF source on that plane relative to antenna boresight. A similar process is conventionally used to shift a difference pattern aligned with the plane of elevation to determine a position of the RF source on that plane relative to antenna boresight. This concept is illustrated in FIG. 4 which shows the squint angles θₐ and θₑ in the azimuth and elevation planes, respectively. In one instance the antenna beam is scanned in the azimuth plane and in the other instance, the antenna beam is scanned in the elevation plane.

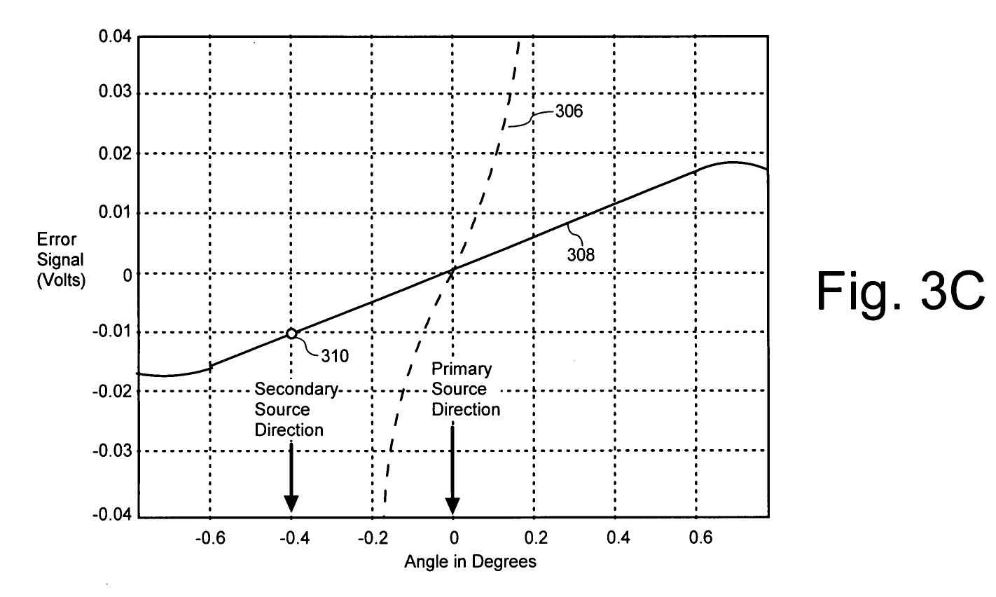

X Referring now to FIG. 5, there is shown a conceptual representation of a tracking antenna 500. Tracking antenna 500 is part of a tracking system as described in relation to FIG. 1 or 2 so that it tracks a primary RF source identified as “X” in FIG. 5. Tracking antenna 500 has a beam-width 504. In this regard, it can be observed in FIG. 5 that the tracking antenna 500 also has a boresight axis 502, which is aligned with the primary RF source X. The tracking system changes the orientation of the antenna as necessary so that the boresight axis of the antenna tracks the position of the primary RF source X as the RF source X moves. The primary RF source X can be an earth orbiting communications satellite, in which case the tracking antenna 500 will maintain the boresight axis in alignment with the primary RF source X. However, it will be understood by those skilled in the art that the invention is not limited in this regard. Other application examples may be for observing two closely positioned airborne sources or possibly other non-satellite space-borne targets in a radar system.

It can be observed in FIG. 5, that primary RF source X can be closely spaced together among a cluster of secondary RF sources Y₁ and Y₂. For example, certain types of satellite services are known to cluster several satellites together to provide users with additional communications bandwidth. In such cases, it is often useful to obtain information relating to the relative position of the satellites in the cluster. For example, it can be useful to know the relative distances between the primary RF source X and the secondary RF sources Y₁, Y₂. It can also be useful to know the distance between and among the various secondary RF sources Y₁, Y₂. However, it will be appreciated that the primary RF source and the secondary RF sources do not necessarily transmit RF energy on RF frequencies which are in identical frequency bands and/or which have the same polarizations.

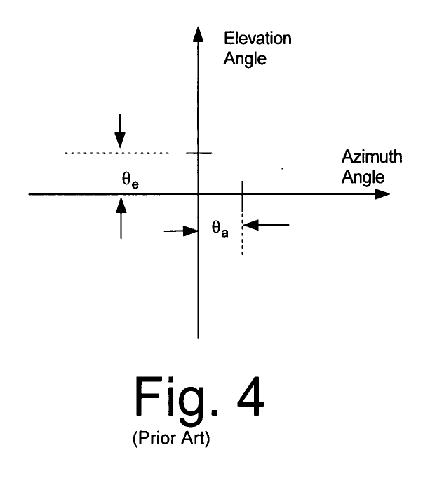

Referring now to FIG. 6, there is shown an example block diagram of a system that provides pseudomonopulse antenna tracking of a primary RF source and also features direction finding of multiple nearby secondary sources using any monopulse technique. As shown in FIG. 6, a conventional pseudomonopulse antenna tracking system 200 can be combined with additional circuitry to provide a system that efficiently provides both of these functions.

The features of antenna tracking system 200 have been generally described in relation to FIG. 2. Accordingly, a detailed discussion of the components comprising antenna tracking system 200 will not be repeated here. However, it should be understood that the antenna tracking system 200 incorporated in the system shown in FIG. 6 is merely one possible implementation of such a monopulse tracking system, and the invention is not limited in this regard. Alternative monopulse tracking systems similar to antenna tracking system 100 or 200 can also be used. All that is required is that the antenna tracking system provides one or more tracking error signals in one or more reference planes (e.g. azimuth and elevation) for generating a tracking control signal 618. Tracking control signal 618 is a digital or analog signal that can be used to maintain an antenna boresight position of tracking feed 201 directed toward a primary RF source. Such monopulse tracking systems are well known in the art.

Referring to antenna tracking system 200, the analog error signal output from LNA 212 is advantageously communicated to an A/D converter 614. The A/D converter 614 generates a digital output representative of the analog input and communicates this digital output to processor 616. Processor 616 can include any suitable microprocessor programmed with a set of instructions for generating a tracking control signal 618 responsive to the digital input from A/D converter 614. The control signal 618 can thereafter be utilized in a closed servo loop system. The servo loop system is used for controlling a boresight position for the antenna associated with feed 102. Such servo loop systems are well known in the art and therefore will not be described in detail herein.

The system in FIG. 6 also includes another monopulse direction finding system. In particular a secondary direction finding system 600 is provided that includes one or more antenna feeds 601, 602, 603, 604 which communicate RF energy to RF comparator 606. The one or more RF feeds 601, 602, 603, 604 are advantageously mounted on a single rotating structure together with the RF feed 102. The various techniques by which such an arrangement can be implemented will be described in more detail below.

The secondary direction finding system 600 can include an RF comparator 606 which produces outputs defined as sum channel, difference channel (azimuth), and difference channel (elevation). These outputs are communicated to monopulse RF processing block 608 which generates azimuth and elevation output signals representative of the position of the secondary RF sources. These analog outputs are communicated to A/D converters 610, 612 where they are converted to digital representations of the analog inputs. The digital outputs for azimuth and elevation are then communicated to the processor 616.

Those skilled in the art will appreciate that monopulse type secondary direction finding system 600 is presented as one possible arrangement for a monopulse direction finding system. There are a wide variety of methods and techniques for monopulse or pseudomonopulse direction finding which are known in the art. Any such known techniques can be used with the present invention, provided that the output of such system includes information relating to the position of one or more secondary RF sources of predetermined frequency and polarization. Moreover, secondary direction finding system 600 is shown as utilizing a plurality of RF feeds distinct from the RF feed used for system 200. However, the invention is not limited in this regard. In one embodiment, a single antenna aperture and a single RF feed are used to receive RF signals from the primary RF source and the two or more of secondary RF sources. For example a single reflector and single RF feed could be used for this purpose. A single common RF feed in that case would be coupled to the monopulse tracking system and the monopulse direction finding system. Such a system can be used in those instances where the primary RF source and the secondary RF source operate on the same band and with the same polarization. However, in many instances, this will not be the case. All that is necessary is some information to distinguish the sources, such as frequency, polarization, coding, pilot tones, etc. Accordingly, more than one RF aperture and/or feed can be provided in order to separately receive the signals from the primary and secondary RF sources.

Regardless of the specific monopulse architecture selected for the secondary direction finding system 600, the processor 616 can use the information from A/D converters 614, 610 and 612 to determine a relative position of a secondary RF source with respect to the primary RF source. In particular, the spatial position of the primary RF source X can be determined as previously described using the information from A/D converter 614. The information may be converted from an error signal amplitude to a differential angular position between the primary and secondary sources. The processor 616 also determines a position of one or more secondary RF sources. In this way, a spatial position of a secondary RF source, such as Y₁ or Y₂, can thereafter be determined relative to the primary RF source X by comparing the angular position of the secondary RF sources to that of the primary RF source. This process can be understood by reference to FIG. 3C.

FIG. 3C shows error signal curves 306, 308 which are generated by antenna tracking system 200 and secondary direction finding system 600, respectively. The overlapping nature of these curves allows a position of a primary RF source, which is being tracked, to be related to a position of a secondary source, whose location is being determined. This significant advantage of this invention is achieved by mounting the antenna feeds 202, 601, 602, 603, 604 on a common antenna structure. If the two curves are properly calibrated, and the feeds are adjusted to correspond to a common boresight angle, then standard monopulse techniques can be used to track a primary source using antenna tracking system 200. Moreover, the error signal generated by a secondary direction-finding system 600, can provide accurate information about the location of the secondary source relative to the primary source. Accordingly, the present invention advantageously uses the combined error signal curve 306 coupled with the second error signal curve 308. The primary and/or secondary curves could be generated from either pseudo-monopulse or monopulse techniques at the same point in time.

Referring again to FIG. 6, it can be observed that the output voltage of A/D 614 will vary in accordance with primary source error curve 306 in response to a range of angular positions of a primary RF source X. The output voltage from A/D 610 and 612 will vary in accordance with secondary source error curve 308 in response to a range of angular positions of a secondary RF source Y₁ or Y₂. As shown in FIG. 3C, an antenna boresight can be maintained pointed toward a primary RF source by continuously adjusting a position of an antenna so that the error signal voltage is maintained at or around zero volts on primary source error curve 306. Concurrently, the angular position of the secondary RF source in the azimuth or elevation plane relative to the primary RF source can be determined by comparing an error signal output voltage from A/D 610 or 612 respectively. For example, in FIG. 3C, the secondary error voltage signal is −0.01, which corresponds to an angular offset from boresight of −0.4 degrees. In this way, an angular distance between the primary RF source and one or more secondary RF sources can be computed. If the arrangement of a satellite cluster is generally known, then this distance between the primary and secondary RF sources can also be used to determine a relative distance between one secondary source and another secondary source.

In a typical satellite cluster, the operating frequency of the various satellites in the cluster is often different from satellite to satellite so as to avoid interference. Alternatively, or in addition to such frequency variations, a polarization of signals transmitted by each satellite can be different from satellite to satellite. These differences can generally make it difficult to use a single monopulse antenna aperture to concurrently obtain position information for all of the primary and secondary RF sources. In order to overcome this problem, the feed 202 can be configured for operating on a different frequency and/or different polarization as compared to the feeds 601, 602, 603, 604.

Further, the feeds 202, 601, 602, 603, 604 are advantageously mounted to a common mechanical structure so that they rotate and pivot as one in the azimuth and elevation planes. With such an arrangement, an error signal developed by the antenna tracking system 200 at a primary RF source frequency band is used to control the position of the structure. Consequently, the boresight axis of the antenna aperture associated with feed 202 is pointed toward a source direction. Concurrently, position information is developed by the secondary direction finding system 600. Secondary direction finding system 600 receives signals from at least one secondary RF source which operates at a secondary frequency band or bands. This position information developed by secondary direction finding system 600 is used to concurrently measure the position of nearby source relative to the boresight axis of the antenna aperture associated with feed 202. This boresight axis will correspond to the direction of the primary RF source. Therefore, in a properly calibrated system, the exact offset angle and direction of any secondary source relative to the antenna boresight direction (direction of the primary source) can be accurately determined. Accordingly, the foregoing arrangement provides a means for direction finding of multiple sources using a single antenna. As hereinafter described, the single antenna can include a single antenna aperture with multiple feeds, or multiple antenna apertures, each with their own feed or feeds.

The present invention can be implemented using a combination of reflector or array type antennas. As used herein, reflector type antenna refers to any antenna system that includes a reflector which directs RF energy toward at least one RF feed. Typically, the reflector will define a curved surface which is parabolic or approximately parabolic. However, the invention is not limited in this regard. As used herein, array type antenna refers to an antenna which is formed from a plurality of individual apertures which fed from a common source by means of a beam forming network. The beam forming network controls at least one of the phase and amplitude of signals communicated to each individual aperture to control the shape and pointing direction of the beam.

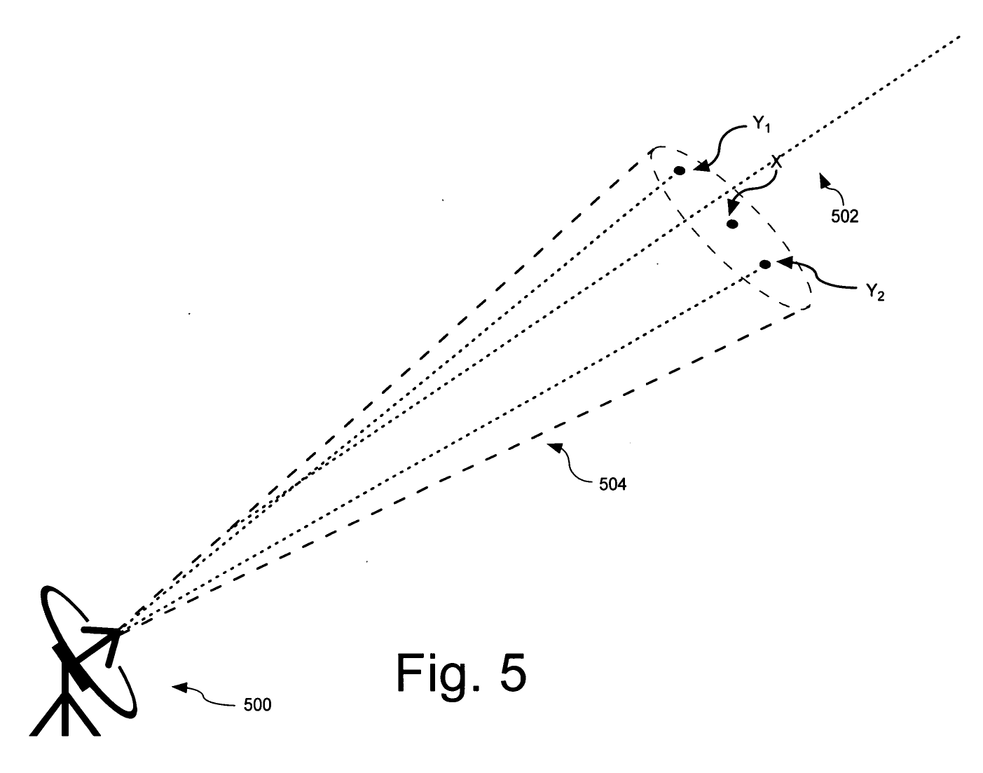

Referring now to FIGS. 7-9, there are shown schematic representations of several different antenna arrangements that can be used with the present invention. Notably, in each antenna at least one aperture is provided for tracking a primary RF source, and at least a second aperture is provided for determining a position of one or more secondary RF sources. Referring to FIG. 7, there is shown a multiple aperture antenna system 700 that uses reflector and array antennas. The antenna system 700 includes a reflector type antenna 705 comprising a reflector 706 which has a generally parabolic shape, and RF feed 202. The reflector 706 and the RF feed 202 operate in a conventional manner to receive signals from the primary RF source. The plurality of array antennas 701, 702, 703, 704 communicates RF signals respectively to RF feeds 601, 602, 603, 604. Each array shown is intended to indicate a specific frequency band and special plane. Arrays are paired to develop orthogonal plane error signals. For example, Arrays 701 and 702 may operate at frequency band A and produce orthogonal error signals in band A, while Arrays 703 and 704 may operate at frequency band B and produces orthogonal error signals in band B.

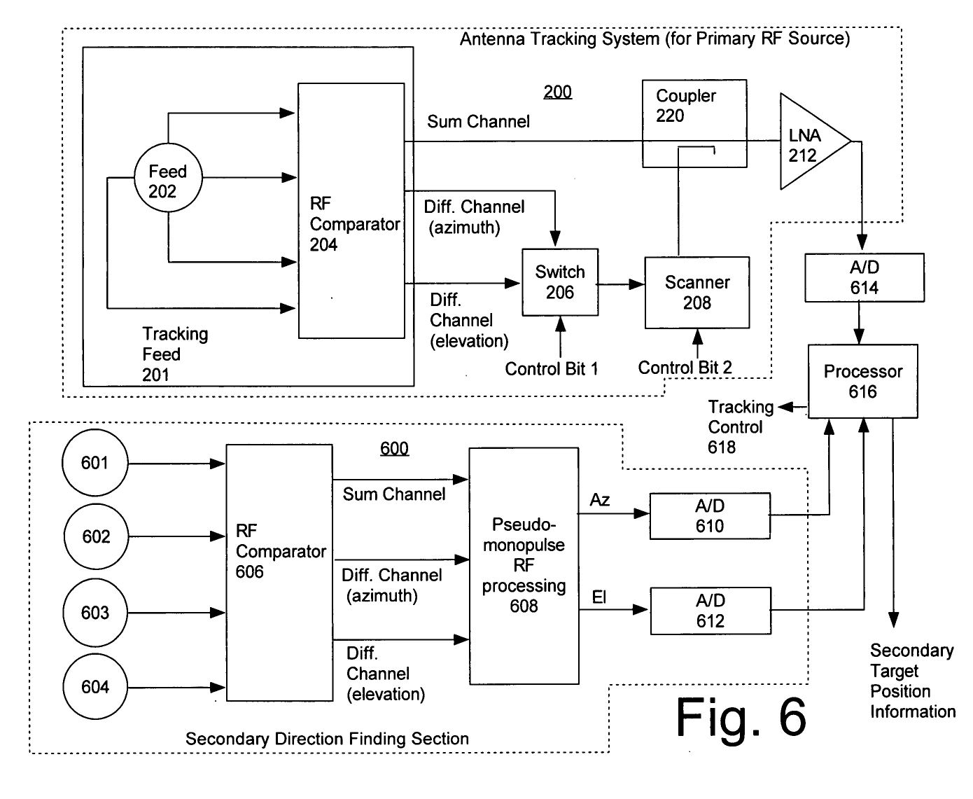

In FIG. 8, there is shown an antenna system 800 comprised of a common reflector 801 that is used with two separate feeds 804, 802. Feed 804 is located at the focal point of the reflector 801 (a prime focus feed) and the second feed 802 is arranged in a Cassegrain geometry with a dichroic subreflector 803. The dichroic subreflector 803 is formed from a frequency selective surface that passes RF signals communicated to and from the RF feed 804 and reflects RF signals intended for RF feed 802. Either RF feed 802, 804 can be used to keep the antenna boresight axis pointed toward the primary RF source. The other RF feed 802, 804 not used for tracking is used for direction finding with respect to the secondary RF sources.

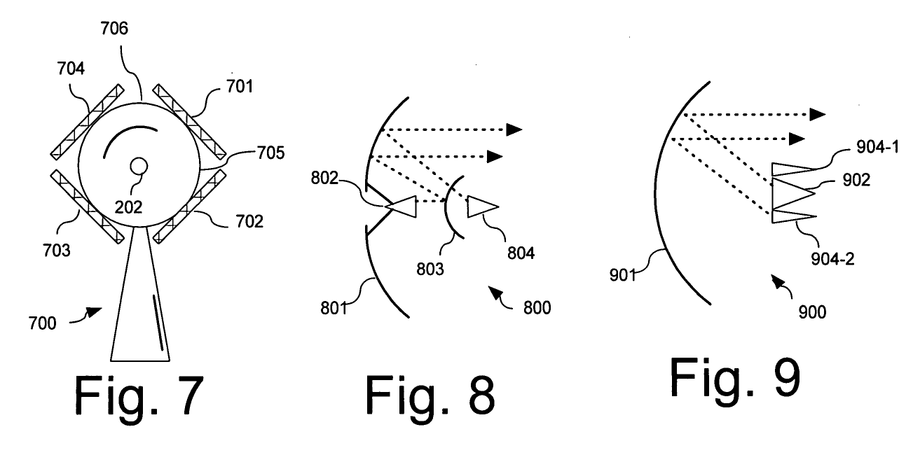

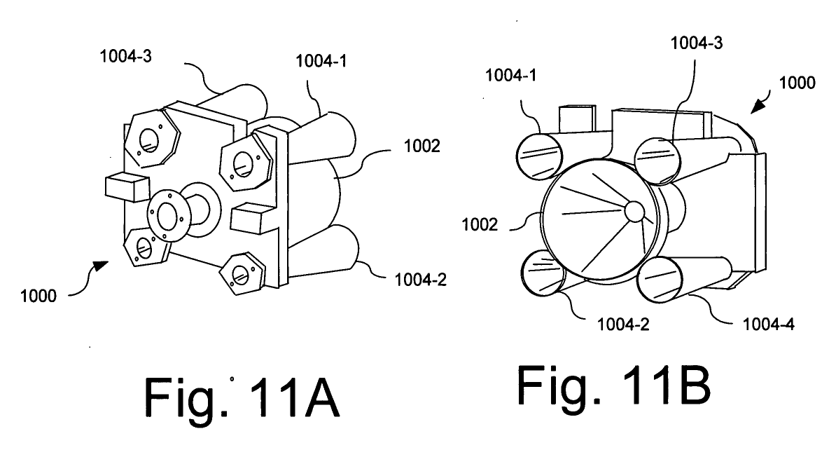

In FIG. 9, there is shown an antenna system 900 which is comprised of a common reflector 901 that is used with two or more RF feeds. A first feed 902 is located at the focal point of the reflector 901 to form a prime focus feed. One or more second RF feeds 904-1, 904-2 are also located substantially at the focal point of the common reflector 901. It will be appreciated that as many as four second RF feeds can be used in this arrangement to provide direction finding functionality in two orthogonal planes (e.g. azimuth and elevation). Such an arrangement will be described in more detail in relation to FIGS. 11A and 11B. In the foregoing embodiment, the feed 902 can be used for tracking the primary RF source and the secondary RF feed(s) 904-1, 904-2 can be used for direction finding with respect to the secondary RF sources. Alternatively, the function of the feeds can be reversed. In either case, the reflector 901 forms a single aperture that functions for both sets of RF feeds. Also it is possible to achieve a similar result using a Cassegrain configuration as described in the following section.

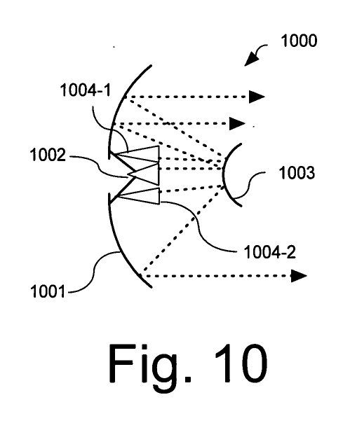

In FIG. 10, there is shown an antenna system 1000 which is comprised of a common reflector 1001 that is used with two or more RF feeds. The antenna system 1000 is arranged with both sets of feeds in a Cassegrain configuration which utilizes a subreflector 1003. The feeds include a first feed 1002 and one or more second RF feeds 1004-1, 1004-2. It will be appreciated that while only two second RF feeds are shown in FIG. 10, the invention is not limited in this regard. For example, it can be desirable to use four or more second RF feeds in this arrangement to provide direction finding functionality in two orthogonal planes (e.g. azimuth and elevation). Such an arrangement will be described in more detail in relation to FIGS. 11A and 11B. In the foregoing embodiment, the feed 1002 can be used for tracking the primary RF source and the secondary RF feeds 1004-1, 1004-2 can be used for direction finding with respect to the secondary RF sources. Alternatively, the function of the feeds can be reversed. In either case, the reflector 1001 and subreflector 1003 form a single aperture that functions for both sets of RF feeds.

Referring now to FIGS. 11A and 11B, there is shown two perspective views of an example of an integrated RF feed system that could be used with the embodiments of the invention described in FIGS. 9 and 10. For convenience, the RF feed system will be described in relation to the embodiment shown in FIG. 10. Thus it can be observed that the integrated RF feed system 1000 includes a first RF feed 1002. The integrated RF feed system 1000 also includes one or more second RF feeds. In the embodiment shown, four RF feeds 1004-1, 1004-2, 1004-3, and 1004-4 are used for this purpose. The four RF feeds generate a sum and difference pattern in an azimuth and elevation plane. The arrangement of the four feed horns as shown is well known in the monopulse radar field for generating sum and difference patterns in the azimuth and elevation planes. Notably, the four feeds 1004-1, 1004-2, 1004-3, and 1004-4 can be retrofitted around an existing RF feed 1002. Consequently, an existing RF feeds 1002 can be retrofit for direction finding on secondary RF sources at different frequencies and/or polarizations.

With the arrangements described herein, a single antenna system can be used to track a primary RF source while concurrently performing a direction finding function with respect to one or more secondary RF sources. The solution allows existing antennas to be upgraded to operate on multiple sources. For example, a single antenna system can be used to monitor the position of a cluster of closely spaced satellites. The single antenna system can measure a relative distance between satellites in the cluster. Similarly for multiple airborne or spaceborne sources other than satellites.

Throughout this application, the invention has been described as a pseudo-monopulse type system. However, it will be understood that all of the foregoing methods and apparatus can also be applied to monopulse systems and operations. Accordingly, the invention is not limited in this regard.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A method for tracking a position of a plurality of secondary RF sources arrayed about a position of a primary RF source, comprising:
tracking with a communication antenna system a position of a primary RF source using a monopulse or pseudomonopulse tracking technique applied to signals communicated from a first RF feed;
using signals received with said communication antenna system on a second RF feed to concurrently determine a position of a plurality of secondary RF sources arrayed about a position of said primary RF source and having at least one of a different frequency and a different polarization as compared to said primary RF source, wherein said determining step comprises using a monopulse or pseudomonopulse direction finding technique; and
positioning said first RF feed and said second RF feed on a common rotating structure.

2. The method according to claim 1, further comprising selecting said communication antenna system to include a first and second antenna aperture.

3. The method according to claim 2, further comprising selecting each of said first and second antenna aperture from the group consisting of a reflector type antenna and an array type antenna.

4. The method according to claim 1, further comprising using a common reflector to focus RF signals from said primary RF source toward said first RF feed, and to focus RF signals from said secondary RF source toward said second RF feed.

5. The method according to claim 4, further comprising selecting said first and second RF feed to include a microwave horn.

6. The method according to claim 5, further comprising positioning said first and said second RF feed to define a prime focus feed system for said common reflector.

7. The method according to claim 5, further comprising positioning a subreflector in a path of RF signals communicated from said common reflector to said first and said second RF feed.

8. The method according to claim 7, further comprising forming said subreflector as a frequency selective surface, and communicating RF signals to at least one of said first and second RF feed horns through a surface said subreflector.

9. The method according to claim 5, further comprising selecting said first RF feed to have at least one of a different polarization and a different operating frequency band as compared to said at least one second RF feed.

10. The method according to claim 1, wherein said step of determining a position of said plurality of secondary RF sources further comprises determining an angular position difference between said primary RF source and at least one secondary RF source using information obtained from said monopulse or pseudomonopulse tracking technique, and said monopulse or pseudomonopulse direction finding.

11. The method according to claim 1, wherein said step of determining a position of a plurality of secondary RF sources further comprises determining a relative distance between said primary RF source and at least one of said secondary RF sources.

12. The method according to claim 1, wherein said primary RF source and said secondary RF sources comprise a cluster of earth orbiting satellites.

13. A method for tracking a position of a plurality of secondary RF sources arrayed about a position of a primary RF source, comprising:
tracking with a communication antenna system a position of a primary RF source using a monopulse or pseudomonopulse tracking technique, said tracking technique comprising automatically adjusting a boresight position of said communication antenna system to follow a position of said primary RF source;
using signals received with said communication antenna system to concurrently determine a position of a plurality of secondary RF sources arrayed about a position of said primary RF source and having at least one of a different frequency and a different polarization as compared to said primary RF source, wherein said determining step comprises using a monopulse or pseudomonopulse direction finding technique;
performing said monopulse or pseudomonopulse tracking using signals communicated from a first RF feed, and said monopulse or pseudomonopulse direction finding using signals communicated from a second RF feed exclusive of said first RF feed; and
wherein said step of determining a position of said plurality of secondary RF sources further comprises determining an angular position difference between said primary RF source and at least one secondary RF source using information obtained from said monopulse or pseudomonopulse tracking, and said monopulse or pseudomonopulse direction finding.

14. The method according to claim 13, further comprising determining a relative distance between said primary RF source and at least one of said secondary RF sources.

15. The method according to claim 13, wherein said primary RF source and said secondary RF sources comprise a cluster of earth orbiting satellites.

16. A system for finding a direction of a plurality of secondary RF sources arrayed about a position of a primary RF source, comprising:
an antenna system coupled to a monopulse or pseudomonopulse tracking system configured for determining a position of a primary RF source relative to a boresight axis of said antenna system, and for automatically adjusting a boresight position of said antenna system to remain aligned with said primary RF source, said antenna system comprising a first RF feed configured for receiving signals from said primary RF source, and a second RF feed configured for receiving signals from at least one secondary RF source;
a monopulse or pseudomonopulse direction finding system coupled to said second RF feed responsive to RF signals having at least one of a different frequency band and a different polarization as compared to said primary RF feed; and
wherein said first RF feed and said second RF feed are mounted together on a common rotating structure.

17. The system according to claim 16, wherein said antenna system comprises a first and second antenna aperture mounted on said single rotating structure, said first and second aperture respectively coupled to said monopulse or pseudomonopulse tracking system and said monopulse or pseudomonopulse direction finding system.

18. The system according to claim 17, wherein said first and second aperture are selected from the group consisting of a reflector type antenna and an array type antenna.

19. The system according to claim 16, wherein said first RF feed is positioned so that RF signals for said monopulse or pseudomonopulse tracking of said primary RF source are communicated from a reflector to said first RF feed, and wherein said second RF feed is positioned so that RF signals for monopulse or pseudomonopulse direction finding of said plurality of secondary RF source are communicated from said reflector to at least said second RF feed horn.

20. The system according to claim 19, wherein said first and at least said second RF feed are positioned so as to define a prime focus feed system for said reflector exclusive of any subreflector.

21. The system according to claim 19, wherein said antenna system further comprises a subreflector positioned in a path of RF signals communicated from said reflector to said first and said second RF feed.

22. The system according to claim 21, wherein said subreflector is a frequency selective surface that is transmissive with respect to RF signals from said primary RF source or said at least one secondary RF source.

23. The system according to claim 16, wherein said first RF feed is arranged to have at least one of a different polarization and a different operating frequency band as compared to said second RF feed.

24. The system according to claim 16, further comprising processing means for determining an angular difference in position as between said primary RF source and at said secondary RF source.

25. The system according to claim 16, further comprising processing means for determining a distance between said secondary RF sources.

26. A system for finding a direction of a plurality of secondary RF sources arrayed about a position of a primary RF source, comprising:
an antenna system coupled to a monopulse or pseudomonopulse tracking system configured for determining a position of a primary RF source relative to a boresight axis of said antenna system, and for automatically adjusting a boresight position of said antenna system to follow said primary RF source, said antenna system comprising a first RF feed configured for receiving signals from said primary RF source, and a second RF feed configured for receiving signals from at least one secondary RF source;
a monopulse or pseudomonopulse direction finding system coupled to said second RF feed and responsive to RF signals having at least one of a different frequency and a different polarization as compared to said first RF feed;
processing means for determining a position of said plurality of secondary RF sources relative to said primary RF source using information from said monopulse or pseudomonopulse tracking system and said monopulse or pseudomonopulse direction finding system.
